(19) United States
(12) Patent Application Publication
(10) Pub. No.: US 2026/0331544 A1
(43) Pub. Date: Oct. 22, 2026

(54) MEMBRANE ELECTRODE ASSEMBLY

(71) Applicant: TOYOTA JIDOSHA KABUSHIKI KAISHA, Toyota-shi (JP)

(72) Inventors: Shunsuke TAKAHASHI, Numazu-shi (JP); Masayuki Kimura, Toyota-shi (JP); Ryo Shimizu, Fuji-shi (JP)

(73) Assignee: TOYOTA JIDOSHA KABUSHIKI KAISHA, Toyota-shi (JP)

(21) Appl. No.: 19/541,611

(22) Filed: Feb. 17, 2026

(30) Foreign Application Priority Data
Apr. 16, 2025 (JP) 2025-067695

(51) Int. Cl. H01M 8/1004; H01M 4/88; H01M 4/90; H01M 4/92; H01M 8/1018

(52) U.S. Cl. CPC H01M 8/1004; H01M 4/8807; H01M 4/8828; H01M 4/9008; H01M 4/9075; H01M 4/926; H01M 8/1018

(57) ABSTRACT

An embodiment of the present disclosure is a membrane electrode assembly including: a solid polymer electrolyte membrane; an anode catalyst layer disposed on a first surface of the solid polymer electrolyte membrane; and a cathode catalyst layer disposed on a second surface of the solid polymer electrolyte membrane. The membrane electrode assembly contains a metal ion selected from cerium ions and manganese ions, and a compound that is able to coordinate to the metal ion. The compound that is able to coordinate to the metal ion is a compound having two or more macrocyclic ligands or a salt of the compound.

### CROSS-REFERENCE TO RELATED APPLICATION

This application claims priority to Japanese Patent Application No. 2025-067695 filed on Apr. 16, 2025. The disclosure of the above-identified application, including the specification, drawings, and claims, is incorporated by reference herein in its entirety.

### BACKGROUND

### 1. Technical Field

The present disclosure relates to membrane electrode assemblies.

### 2. Description of Related Art

A polymer electrolyte fuel cell typically includes a membrane electrode assembly (MEA) including a solid polymer electrolyte membrane, which serves as an electrolyte membrane, an anode catalyst layer disposed on one surface of the solid polymer electrolyte membrane, and a cathode catalyst layer disposed on the other surface of the solid polymer electrolyte membrane. The anode catalyst layer functions as a fuel electrode, and the cathode catalyst layer functions as an air electrode. Gas diffusion layers may further be disposed on both sides of the MEA. This configuration is referred to as a membrane electrode and gas diffusion layer assembly (MEGA).

In a polymer electrolyte fuel cell, hydrogen peroxide (H₂O₂) may be generated from water and oxygen in the catalyst layers during power generation, and hydroxyl radicals (OH) may be generated from hydrogen peroxide. Such hydrogen peroxide and hydroxyl radicals cause degradation of electrolyte resins such as ionomers contained in the solid polymer electrolyte membrane and in the catalyst layers.

Accordingly, techniques have been proposed in which a radical scavenger such as cerium ions is incorporated into the MEA to render hydroperoxy radicals generated during power generation of the fuel cell harmless, thereby improving the durability of the MEA. Techniques have also been proposed in which cerium ions and an organic compound capable of forming an inclusion compound with the cerium ions are incorporated into the MEA to improve the durability of the MEA.

For example, Japanese Unexamined Patent Application Publication No. 2008-130460 (JP 2008-130460 A) discloses a solid polymer electrolyte membrane formed from a polymer electrolyte having sulfonic acid groups. The solid polymer electrolyte membrane contains any one of the following (a) to (c): (a) cerium ions and an organic compound (X) capable of forming an inclusion compound with the cerium ions; (b) an inclusion compound (Y) formed from the organic compound (X) in which the cerium ions are included; and (c) either or both of the cerium ions and the organic compound (X), and the inclusion compound (Y). Specifically, J P 2008-130460 A discloses a polymer electrolyte membrane or an anode catalyst layer that contains cerium ions and 18-crown-6 ether or 15-crown-5 ether.

### SUMMARY

However, in conventional membrane electrode assemblies such as that disclosed in JP 2008-130460 A, a decrease in performance has sometimes been observed during use, indicating that there remains room for improvement in durability. An object of the present disclosure is to provide a membrane electrode assembly having excellent durability.

The inventors conducted extensive studies to address the above issue and found that using a compound having two or more macrocyclic ligands, or a salt thereof, improves the durability of the membrane electrode assembly, thereby leading to the present disclosure.

Therefore, example aspects of the present embodiment are as follows.

(1) A membrane electrode assembly including: a solid polymer electrolyte membrane; an anode catalyst layer disposed on a first surface of the solid polymer electrolyte membrane; and a cathode catalyst layer disposed on a second surface of the solid polymer electrolyte membrane, wherein:
the membrane electrode assembly contains a metal ion selected from cerium ions and manganese ions, and
a compound that is able to coordinate to the metal ion; and
the compound that is able to coordinate to the metal ion is a compound having two or more macrocyclic ligands or a salt of the compound.
   (2) The membrane electrode assembly according to (1), wherein: the compound that is able to coordinate to the metal ion is a compound in which two or more macrocyclic ligands are linked by a linking group, or a salt of the compound; and the macrocyclic ligands are crown ether structures.
   (3) The membrane electrode assembly according to (2), wherein the linking group is an alkylene group having 3 to 20 carbon atoms in a main chain, a —CH₂— in the main chain of the alkylene group may be substituted with at least one selected from —O— and —NR—, and R is independently a hydrogen atom or an alkyl group having one to six carbon atoms.
   (4) The membrane electrode assembly according to any one of (1) to (3), wherein:
the compound that is able to coordinate to the metal ion is a compound in which two macrocyclic ligands are linked by a linking group;
the two macrocyclic ligands are identical and are crown ether structures having a ring size of 18 or less; and
the linking group is an alkylene group having 3 to 20 carbon atoms in a main chain, and two to four of —CH₂— units in the main chain of the alkylene group are substituted with at least one selected from —O— and —NR—, and R is independently a hydrogen atom or an alkyl group having one to six carbon atoms.
   (5) The membrane electrode assembly according to (4), wherein:
the two macrocyclic ligands are identical and are 12-crown-4 ether or 15-crown-5 ether; and
the linking group is an alkylene group having 3 to 12 carbon atoms in a main chain, and two of —CH₂— units in the main chain of the alkylene group are substituted with at least one selected from —O— and —NR—, and R is independently a hydrogen atom or an alkyl group having one to six carbon atoms.

The present disclosure can provide a membrane electrode assembly having excellent durability.

### DETAILED DESCRIPTION OF EMBODIMENTS

### Membrane Electrode Assembly

An embodiment of the present disclosure is a membrane electrode assembly including a solid polymer electrolyte membrane, an anode catalyst layer disposed on a first surface of the solid polymer electrolyte membrane, and a cathode catalyst layer disposed on a second surface of the solid polymer electrolyte membrane. The membrane electrode assembly contains a metal ion selected from cerium ions and manganese ions, and a compound that is able to coordinate to the metal ion. The compound that is able to coordinate to the metal ion is a compound having two or more macrocyclic ligands, or a salt of the compound.

The present embodiment can provide a membrane electrode assembly having excellent durability. In the present embodiment, the metal ion, selected from cerium ions and manganese ions, that functions as a radical scavenger is incorporated into the membrane electrode assembly (for example, into the anode catalyst layer or the solid polymer electrolyte membrane). Since such metal ions can capture hydroperoxy radicals and render them harmless, degradation of the membrane electrode assembly can be suppressed. Furthermore, by incorporating the compound that is able to coordinate to the metal ion into the membrane electrode assembly, migration of the metal ions can be suppressed and concentration unevenness can be reduced. Since a compound having two or more macrocyclic ligands, or a salt of that compound, is used as the compound that is able to coordinate to the metal ion, migration of the metal ions can further be suppressed. Accordingly, the membrane electrode assembly of the present embodiment has excellent durability.

Hereinafter, the configuration of the present embodiment will be described.

The solid polymer electrolyte membrane blocks the passage of electrons and gases while allowing protons (H⁺) generated at the anode to migrate from the anode catalyst layer to the cathode catalyst layer. Any electrolyte membrane having proton conductive properties known in the art may be used as the solid polymer electrolyte membrane in the present embodiment. A membrane formed from a fluororesin electrolyte having sulfonic acid groups (such as Nafion (DuPont), Flemion (AGC Inc.), and Aciplex (Asahi Kasei Corporation)) may be used. As the solid polymer electrolyte membrane, The thickness of the solid polymer electrolyte membrane is not limited to a particular value, and may be, for example, 5 μm to 50 μm from the standpoint of improving proton conductive properties.

The cathode catalyst layer functions as an air electrode (oxygen electrode). The cathode catalyst layer contains at least an electrode catalyst (also simply referred to as “catalyst”) and an electrolyte. A supported metal catalyst is preferred as the electrode catalyst. In a supported metal catalyst, a metal catalyst is supported on a support material.

The support material is not limited to a particular type, and may be any support material known in the art. Examples of support materials include carbon materials such as carbon black, carbon nanotubes, and carbon nanofibers, and carbon compounds such as silicon carbide. A single support material may be used alone, or two or more support materials may be used in combination.

The metal catalyst is not particularly limited as long as it exhibits catalytic activity in the electrode reaction. Metal catalysts that can be used include, but are not limited to, platinum, palladium, rhodium, and alloys of two or more of these metals. Platinum alloys that can be used include, but are not limited to, alloys of platinum with either or both of cobalt and ruthenium. A single metal catalyst may be used alone, or two or more metal catalysts may be used in combination.

The content of the electrode catalyst in the cathode catalyst layer is not limited to a particular value, and may be, for example, about 3 mass % to 40 mass % of the total mass of the catalyst layer.

The electrolyte used in the cathode catalyst layer is preferably an ionomer having sulfonic acid groups. An ionomer, also referred to as a cation exchange resin, exists as clusters formed from ionomer molecules. The ionomer is not limited to any particular type, and may be any ionomer known in the art. Examples include ionomers having sulfonic acid groups. Examples of ionomers having sulfonic acid groups include, but not limited to, ion-conductive polymer electrolyte resins such as perfluorosulfonic-acid ionomers. Specific 20 examples of ionomers having sulfonic acid groups include Nafion and Aquivion (Solvay).

The anode catalyst layer functions as a fuel electrode, that is, a hydrogen electrode. The anode catalyst layer contains an electrode catalyst and an ionomer. The ionomer is preferably one having sulfonic acid groups. Examples of ionomers having sulfonic acid groups include the ionomers described above. In one embodiment, the anode catalyst layer may contain, in addition to the electrode catalyst and the ionomer, a metal ion selected from cerium ions and manganese ions, and a compound that is able to coordinate to the metal ion.

The electrode catalyst is not limited to a particular type, and may be any of the materials described above.

The membrane electrode assembly of the present embodiment contains a metal ion selected from cerium ions and manganese ions, and a compound that is able to coordinate to the metal ion. Cerium ions and manganese ions function as radical scavengers and can capture hydroperoxy radicals and render them harmless, thereby suppressing degradation of the membrane electrode assembly. Furthermore, by incorporating the compound that is able to coordinate to the metal ion into the membrane electrode assembly, migration of the metal ions can be suppressed and concentration unevenness can be reduced.

The metal ion is selected from cerium ions and manganese ions Cerium ions and manganese ions may be trivalent or tetravalent.

Examples of cerium salts that can serve as sources of cerium ions include, but are not limited to, cerium nitrate and cerium carbonate. Organic metal complexes of cerium may also be used. A single cerium salt may be used alone, or two or more cerium salts may be used in combination.

Manganese salts that can serve as sources of manganese ions include, but are not limited to, manganese nitrate. A single manganese salt may be used alone, or two or more manganese salts may be used in combination.

In the present embodiment, the compound that is able to coordinate to the metal ion can coordinate to cerium ions or manganese ions, thereby forming a complex between this compound and the cerium ions or manganese ions. At least part of the metal ions form a complex with the compound that is able to coordinate the metal ion. A single compound that is able to coordinate to the metal ion may be used alone, or two or more such compounds may be used in combination.

In the present embodiment, the compound that is able to coordinate to the metal ion selected from cerium ions and manganese ions (hereinafter also referred to as the compound that is able to coordinate to the metal ion) is a compound having two or more macrocyclic ligands, or a salt of such a compound. A compound having two or more macrocyclic ligands or a salt of such a compound readily donates electrons to metal ions such as cerium ions and forms coordination bonds, and as a result can form complexes more effectively. The number of macrocyclic ligands in the compound that is able to coordinate to the metal ion may be, for example, two, three, or four, and may particularly be two or three, and is two from the standpoint of reducing cost. The two or more macrocyclic ligands may be identical or different. In one embodiment, the two or more macrocyclic ligands are identical.

In one embodiment, the macrocyclic ligand is a crown ether structure. A crown ether structure readily donates electrons to metal ions such as cerium ions and thereby forms coordination bonds. In the membrane electrode assembly according to the present embodiment, using a compound having two or more crown ether structures as ligands makes it possible to further suppress migration of the metal ions than when using a compound having one crown ether structure or a crown ether monomer.

In the present specification, the term “crown ether structure” refers to a cyclic structure having a repeating unit of (—CH₂— CH₂—Y—) or (—CH₂— CH₂— CH₂—Y—). Y is independently at least one selected from —O— and —NR—, and R is independently a hydrogen atom or an alkyl group having one to six carbon atoms. The ring size of the crown ether structure may be, for example, 18 atoms or less, and in one embodiment, 15 atoms or less. The crown ether structure is not particularly limited, and examples include 12-crown-4 ether, 15-crown-5 ether, and 18-crown-6 ether. The crown ether structure may also include an aromatic ring or an aliphatic ring.

In one embodiment, the compound that is able to coordinate to the metal ion is a compound in which two or more macrocyclic ligands are linked by a linking group, or a salt of such a compound. In this embodiment, when the compound that is able to coordinate to the metal ion has three or more macrocyclic ligands, each macrocyclic ligand is linked to at least one other macrocyclic ligand. In this embodiment, for example, a first macrocyclic ligand may be linked to a second macrocyclic ligand, and the second macrocyclic ligand may be linked to a third macrocyclic ligand.

In one embodiment, the linking group is an alkylene group having 3 to 20 carbon atoms in the main chain. A —CH₂— in the main chain of the alkylene group may be substituted with at least one selected from —O— and —NR—. R is independently a hydrogen atom or an alkyl group having one to six carbon atoms (for example, an alkyl group having one to four carbon atoms). The alkylene group may be a linear alkylene group or a branched alkylene group. That is, the alkylene group may be an alkylene group whose main chain is substituted with an alkyl group or the like.

In one embodiment, the linking group is one in which a —CH₂— of the main chain of the alkylene group is substituted with at least one selected from —O— and —NR—, and particularly, may be substituted with —O—. In one embodiment, two or more —CH₂— units of the main chain of the alkylene group are substituted with the above group(s), and particularly, two to four —CH₂— units, or two —CH₂— units, may be substituted with the above group(s). When a —CH₂— of the main chain is substituted with —O— and/or —NR—, the number of carbon atoms in the main chain of the alkylene group refers to the total of the number of unsubstituted carbon atoms in the main chain and the number of carbon atoms substituted with —O— and the number of carbon atoms substituted with —NR— (that is, the total number of oxygen atoms and nitrogen atoms contained in the main chain of the alkylene group).

In one embodiment, the number of carbon atoms in the main chain of the alkylene group (linking group) is from 3 to 20, and may be from 3 to 12. The number of carbon atoms in the main chain of the linking group represents the distance between two macrocyclic ligands (for example, crown ether structures). When the number of carbon atoms in the main chain of the alkylene group is from 3 to 20, the macrocyclic ligands readily coordinate to the metal ion, and migration of the metal ions can further be suppressed. When the number of carbon atoms in the main chain of the alkylene group is from 3 to 12, migration of the metal ions can even more be suppressed.

In one embodiment, the compound that is able to coordinate to the metal ion is a compound in which two or more macrocyclic ligands are linked by a linking group, or a salt of such a compound, and the macrocyclic ligands are crown ether structures. In this embodiment, the compound that is able to coordinate to the metal ion is a compound in which two or more crown ether structures are linked by a linking group, or a salt of such a compound. A compound in which two or more crown ether structures are linked by a linking group may be referred to as a crown ether dimer, trimer, tetramer, or the like, depending on the number of crown ether structures. The crown ether structures and the linking group may have the characteristics described above.

Specifically, in an embodiment in which the compound that is able to coordinate to the metal ion is a compound in which two or more crown ether structures are linked by a linking group, or a salt of such a compound, the ring size of the crown ether structure is, for example, 18 or less, and particularly, may be 15 or less. The crown ether structure may be, for example, a 12-crown-4 ether or a 15-crown-5 ether. A compound having two or more crown ether structures with ring sizes of 15 or less allows the crown ether structures to coordinate three-dimensionally to metal ions such as cerium ions from above and below. A compound having two or more crown ether structures with ring sizes of 15 or less exhibits higher coordination energies of the crown ether structures for metal ions, and therefore can further suppress migration of the metal ions. Accordingly, the membrane electrode assembly according to this embodiment has high durability.

In one embodiment, the compound that is able to coordinate to the metal ion is a compound in which two crown ether structures are linked by a linking group (also referred to as a crown ether dimer), or a salt of such a compound. In this embodiment, the two crown ether structures (macrocyclic ligands) are identical and are crown ether structures having a ring size of 18 or less. In this embodiment, the linking group is an alkylene group having 3 to 20 carbon atoms in the main chain, and two to four —CH₂— units of the main chain of the alkylene group are substituted with at least one selected from —O— and —NR—. When the compound that is able to coordinate to the metal ion has these characteristics, migration of the metal ions is greatly suppressed, and the membrane electrode assembly exhibits high durability.

In another embodiment in which the compound that is able to coordinate to the metal ion is a crown ether dimer or a salt thereof, the two crown ether structures (macrocyclic ligands) are identical and are 12-crown-4 ether or 15-crown-5 ether. The linking group is an alkylene group having 3 to 12 carbon atoms in the main chain, and two —CH₂— units of the main chain of the alkylene group are substituted with at least one selected from —O— and —NR—. When the compound that is able to coordinate to the metal ion has these characteristics, migration of the metal ions are particularly significantly reduced, and the membrane electrode assembly exhibits high durability.

In one embodiment, the compound that is able to coordinate to the metal ion is a compound of Formula (I), or a salt thereof.

CRE1-(CR¹₂)ₐ—Y¹—X—Y²—(CR²₂)_{b}—CRE2 (I)
(in the formula,
CRE1 and CRE2 are each independently a crown ether structure having a ring size of 18 or less or 15 or less, and are, for example, 12-crown-4 ether or 15-crown-5 ether;
R¹ and R² are each independently H or an alkyl group having one to six carbon atoms (for example, an alkyl group having one to four carbon atoms);
Y¹ and Y² are each independently at least one selected from —O— and —NR—;
X is an alkylene group having one to nine carbon atoms in the main chain, and a —CH₂— in the main chain of the alkylene group may be substituted with at least one selected from —O— and —NR—;
R is independently a hydrogen atom or an alkyl group having one to six carbon atoms (for example, an alkyl group having one to four carbon atoms);
a is an integer from 0 to 4; and
b is an integer from 0 to 4.)

When the compound that is able to coordinate to the metal ion is in the form of a salt, examples of the salt include nitrates, sulfates, carbonates, acetates, and propionates.

The compound that is able to coordinate to the metal ion may be prepared in-house, or may be prepared by, for example, purchasing a commercially available product. When preparing the compound in-house, for example, a crown ether dimer or a salt thereof can be prepared by reacting a compound (A) for forming the linking group with a crown ether compound (B) having a group that is reactive with the compound (A). In this reaction, the molar ratio of the compound (B) to the compound (A) (B/A) may be set to 2 or more. Examples of the compound (A) include a compound having a leaving group at each end of the main chain of an alkylene group, and an alkyl halide can be used. The crown ether compound (B) may have a reactive group (a group that is reactive with the compound (A)) in the cyclic structure, and may have such a reactive group as a substituent on the ring. Examples of reactive groups include hydroxyl groups, amino groups, and alkyl groups bearing any of these groups. When the crown ether compound (B) has an —NH— group in the cyclic structure, the —NH— group can serve as a reactive group. In this case, the nitrogen atom in the cyclic structure is not counted in the number of carbon atoms of the linking group. When the crown ether compound (B) has a reactive group (a group that is reactive with the compound (A)) as a substituent on the ring, the cyclic structure portion of the crown ether compound (the crown ether structure) in the crown ether dimer obtained from the compound (A) and the compound (B) corresponds to the macrocyclic ligand. The portion formed by reaction between the reactive group and the compound (A), which links the two crown ether structures, corresponds to the linking group.

The compound that is able to coordinate to the metal ion and the metal ion can be incorporated into the anode catalyst layer, the solid polymer electrolyte membrane, or both.

When the anode catalyst layer contains the compound that is able to coordinate to the metal ion and the metal ion, the anode catalyst layer contains at least an electrode catalyst, an electrolyte, a metal ion selected from cerium ions and manganese ions, and the compound that is able to coordinate to the metal ion. The metal ions facilitate the conversion of hydroxyl radicals generated from hydrogen peroxide into hydroxide ions and can suppress degradation of the anode catalyst layer.

The total content of the metal ions and the compound that is able to coordinate to the metal ion in the anode catalyst layer is, for example, 0.1 mass % to 20 mass % based on the total solid content of the anode catalyst layer. For the above content, the complex is regarded as a mixture of the metal ions and the compound that is able to coordinate to the metal ion. That is, even when the metal ions and the compound that is able to coordinate to the metal ion form a complex, the above total content refers to the sum of the added amounts of the metal ions and the compound that is able to coordinate to the metal ion.

Regarding the relative ratio of the metal ions and the compound that is able to coordinate to the metal ion in this embodiment, the molar ratio of the compound that is able to coordinate to the metal ion to the metal ions (the number of moles of the compound/the number of moles of the metal ions) is, for example, from 0.1 to 10, and in one embodiment, is from 0.5 to 2.

### Method for Manufacturing Membrane Electrode Assembly

The catalyst layer can be formed, for example, by the following steps: preparing a catalyst ink containing an electrode catalyst, an ionomer, and a solvent (e.g., having a solid content of about 10%); applying the catalyst ink onto the surface of a substrate and forming a catalyst layer on the substrate surface by evaporating the solvent from the applied coating; and transferring the catalyst layer on the substrate surface onto the electrolyte membrane. Alternatively, the catalyst layer may be formed by directly applying the catalyst ink onto the solid polymer electrolyte membrane instead of onto a substrate. A membrane electrode assembly can be produced by forming a cathode catalyst layer and an anode catalyst layer on the solid polymer electrolyte membrane.

In forming the anode catalyst layer, the catalyst ink for forming the anode catalyst layer may contain the metal ion and the compound that is able to coordinate to the metal ion. Specifically, the catalyst ink for forming the anode catalyst layer may contain an electrode catalyst, an ionomer (e.g., an ionomer having sulfonic acid groups), the metal ion, the compound that is able to coordinate to the metal ion, and a solvent. The metal ion and the compound that is able to coordinate to the metal ion may be added separately or may be added in the form of a complex thereof.

In a case where the solid polymer electrolyte membrane contains the metal ion and the compound that is able to coordinate to the metal ion, these components may be incorporated into the electrolyte membrane by a known method.

### Polymer Electrolyte Fuel Cell

A polymer electrolyte fuel cell uses, as its basic unit, a membrane electrode assembly (MEA) in which catalyst layers (electrodes) are bonded to both surfaces of a solid polymer electrolyte membrane. In a polymer electrolyte fuel cell, a gas diffusion layer is typically disposed outside the catalyst layer. The gas diffusion layer serves to supply reactant gases and electrons to the catalyst layer and may be formed of, for example, carbon paper or carbon cloth. The catalyst layer serves as the site at which the electrode reactions occur.

The present embodiment will now be described below using examples.

### Synthesis of Crown Ether Dimers

### Synthesis Example 1

### 15-Crown-5 Ether Dimer Linker A

A 200-mL round-bottom flask was charged with 7.51 g (0.03 mol) of 2-(hydroxymethyl)-15-crown-5 ether (a crown ether compound) (manufactured by Tokyo Chemical Industry Co., Ltd.). DMF was then added as a solvent, and 0.84 g (0.035 mol) of NaH was added in three portions. The resulting mixture was stirred at room temperature for 10 minutes. Thereafter, 1.13 g (0.01 mol) of 1,3-dichloropropane (a compound for forming the linking group) (manufactured by Tokyo Chemical Industry Co., Ltd.) was added, and the resulting mixture was stirred at room temperature for one hour. While stirring, saturated aqueous ammonium chloride solution was then slowly added dropwise to quench the reaction. The resulting solution was transferred to a separatory funnel and extracted three times with ethyl acetate and water. The ethyl acetate solution was concentrated using an evaporator to obtain a crude product. The crude product was purified by silica gel column chromatography. As a result, 3.8 g of the titled compound (15CRE dimer linker A) (molecular weight: 540) was obtained. In the titled compound, the two 15-crown-5 ether (crown ether) structures were linked by a linking group having seven carbon atoms in the main chain (—CH₂—O—(CH₂)₃—O—CH₂—).

### Synthesis Example 2

### 15-Crown-5 Ether Dimer Linker B

The titled compound (15CRE dimer linker B) (molecular weight: 610) was obtained in an amount of 3.2 g in the same manner as in Synthesis Example 1 except that 1,3-dichloropropane was replaced with 1,8-dichlorooctane.

### Synthesis Example 3

### 12-Crown-4 Ether Dimer Linker A

The titled compound (12CRE dimer linker A) (molecular weight: 452) was obtained in an amount of 4.2 g in the same manner as in Synthesis Example 1 except that 2-(hydroxymethyl)-15-crown-5 ether was replaced with 6.18 g (0.03 mol) of 2-(hydroxymethyl)-12-crown-4 ether.

### Synthesis Example 4

### 15-Crown-5 Ether Dimer Linker C

The titled compound (15CRE dimer linker C) (molecular weight: 554) was obtained in an amount of 4.6 g in the same manner as in Synthesis Example 1 except that 1,3-dichloropropane was replaced with 0.01 mol of 1,3-dichlorobutane (manufactured by Tokyo Chemical Industry Co., Ltd.).

### Synthesis Example 5

### 18-Crown-6 Ether Dimer Linker A

The titled compound (18CRE dimer linker A) (molecular weight: 628) was obtained in an amount of 3.5 g in the same manner as in Synthesis Example 1 except that 2-(hydroxymethyl)-15-crown-5 ether was replaced with 8.83 g (0.03 mol) of 2-(hydroxymethyl)-18-crown-6 ether.

### Synthesis Example 6

### 15-Crown-5 Ether Dimer Linker D

The titled compound (15CRE dimer linker D) (molecular weight: 638) was obtained in an amount of 3.9 g in the same manner as in Synthesis Example 1 except that 1,3-dichloropropane was replaced with 0.01 mol of 1,10-dichlorodecane (manufactured by Tokyo Chemical Industry Co., Ltd.).

### Fabrication of Membrane Electrode Assembly

### Example 1

### Formation of Cathode Catalyst Layer

A carbon-supported platinum catalyst serving as the electrode catalyst was dispersed in an ionomer solution (Nafion DE2020) containing water and ethanol using a bead mill to prepare a catalyst ink. The mass ratio of water to ethanol (water/ethanol) in the catalyst ink was set to approximately 1. The resulting catalyst ink was applied onto a polytetrafluoroethylene sheet and dried to form a cathode catalyst layer. The Pt loading in the cathode catalyst layer was set to 0.25 mg/cm², and the mass ratio of ionomer to carbon support (I/C) was set to 1.0.

### Formation of Complex

A 100-mL round-bottom flask was charged with 0.01 mol of the 15-crown-5 ether dimer linker A (15CRE dimer linker A) obtained in Synthesis Example 1 and 4.34 g (0.01 mol) of cerium (III) nitrate hexahydrate. Ethanol (20 mL) and water (20 mL) were then added. The resulting mixture was stirred at room temperature for 24 hours. Subsequently, the solvent was removed using an evaporator, and the residue was vacuum-dried at 60 °C for one hour to obtain a white solid. From the observation in Fourier transform infrared spectroscopy (FT-IR) that the peak derived from the ether group had shifted to a lower wavenumber, it was confirmed that 15CRE dimer linker A and Ce had formed a complex (Ce/15CRE dimer linker A complex).

### Formation of Anode Catalyst Layer

A carbon-supported platinum catalyst (TEC10E30E, 30% platinum on carbon, manufactured by Tanaka Kikinzoku Kogyo Co., Ltd.) was used as the electrode catalyst. This electrode catalyst and the above complex (Ce/15CRE dimer linker A complex) were dispersed in an ionomer solution (DE2020) containing water, ethanol, and Nafion (registered trademark) to prepare a catalyst ink. The catalyst ink was applied onto a polytetrafluoroethylene sheet and dried to form an anode catalyst layer. The Pt loading in the anode catalyst layer was set to 0.1 mg/cm², the cerium-ion concentration is set to 3 μg/cm², and the concentration of 15CRE dimer linker A was set to 11.6 μg/cm². The mass ratio of ionomer to carbon support (I/C) was set to 1.0.

### Fabrication of Membrane Electrode Assembly

The resulting cathode and anode catalyst layers were thermally transferred onto the respective surfaces of a Nafion (registered trademark) membrane (NR211) to produce the membrane electrode assembly of Example 1. The heat transfer conditions were 140 °C, 50 kgf/cm² (4.90 MPa), and five minutes. The electrode area of the membrane electrode assembly for initial performance testing was 1 cm×1 cm (1 cm²). The electrode area of the membrane electrode assembly for durability testing was 3.6 cm×3.6 cm (12.96 cm²). The membrane electrode assembly was sandwiched between paper gas diffusion layers (GDLs) each having a water-repellent layer, thereby fabricating a test cell.

### Examples 2 to 6

Membrane electrode assemblies of Examples 2 to 6 were prepared in the same manner as in Example 1, except that, in forming the complex, 15-crown-5 ether dimer linker A was replaced with the crown ether dimers (Synthesis Examples 2 to 6) shown in Table 1.

### Comparative Example 1

A membrane electrode assembly of Comparative Example 1 was prepared in the same manner as in Example 1, except that the complex formation was not carried out and, in forming the anode catalyst layer, the complex (Ce/15CRE dimer linker A complex) was replaced with 4.34 g (0.01 mol) of cerium (III) nitrate hexahydrate.

### Comparative Examples 2 to 4

Membrane electrode assemblies of Comparative Examples 2 to 4 were prepared in the same manner as in Example 1, except that, in forming the complex, 0.01 mol of 15-crown-5 ether dimer linker A was replaced with 0.02 mol of 18-crown-6 ether (18CRE; molecular weight 264), 15-crown-5 ether (15CRE; molecular weight 220), or 12-crown-4 ether (12CRE; molecular weight 176), respectively.

### Evaluation of Membrane Electrode Assemblies

### Durability Test: Voltage Retention

The test cell described above (electrode area: 12.96 cm²) was incorporated into a power-generating cell, and a 200-hour durability test was conducted in a low-humidity environment (cell temperature: 95 °C, relative humidity: 40% RH) and a low current density (0.05 A/cm²). In the durability test, the cell pressure was set to 150 kPa, hydrogen was supplied as the anode gas at a flow rate of 1.0 L/min, and air was supplied as the cathode gas at a flow rate of 2.0 L/min. After the durability test, hydrogen and air were supplied to the test cell, and the change in cell voltage at a current density of 0.05 A/cm² was evaluated. The voltage retention was calculated as the ratio of the cell voltage after the 200-hour durability test to the initial cell voltage (voltage after the durability test/initial voltage×100(%)). The results are shown in Table 1 together with the concentrations of the crown ether and the crown ether dimer in the anode catalyst layer.

TABLE 1

| | | | Comparative Example | | | | Example | | | | | |
|---|---|---|---|---|---|---|---|---|---|---|---|---|
| | | Unit | 1 | 2 | 3 | 4 | 1 | 2 | 3 | 4 | 5 | 6 |
| Crown | 18CRE | μg/cm² | | 11.3 | | | | | | | | |
| Ether | 15CRE | μg/cm² | | | 9.4 | | | | | | | |
| | 12CRE | μg/cm² | | | | 7.5 | | | | | | |
| Crown | 18CRE | μg/cm² | | | | | | | | | 13.4 | |
| Ether | Dimer | | | | | | | | | | | |
| Dimer | Linker A | | | | | | | | | | | |
| | 15CRE | μg/cm² | | | | | | | | | | 13.7 |
| | Dimer | | | | | | | | | | | |
| | Linker D | | | | | | | | | | | |
| | 15CRE | μg/cm² | | | | | 11.6 | | | | | |
| | Dimer | | | | | | | | | | | |
| | Linker A | | | | | | | | | | | |
| | 15CRE | μg/cm² | | | | | | 13.1 | | | | |
| | Dimer | | | | | | | | | | | |
| | Linker B | | | | | | | | | | | |
| | 12CRE | μg/cm² | | | | | | | 9.7 | | | |
| | Dimer | | | | | | | | | | | |
| | Linker A | | | | | | | | | | | |
| | 15CRE | μg/cm² | | | | | | | | 11.9 | | |
| | Dimer | | | | | | | | | | | |
| | Linker C | | | | | | | | | | | |
| Evaluation | Initial | V | 0.82 | 0.8 | 0.78 | 0.77 | 0.81 | 0.8 | 0.8 | 0.82 | 0.81 | 0.82 |
| | voltage | | | | | | | | | | | |
| | Voltage | V | 0.54 | 0.63 | 0.61 | 0.61 | 0.78 | 0.73 | 0.74 | 0.78 | 0.69 | 0.71 |
| | after | | | | | | | | | | | |
| | Durability | | | | | | | | | | | |
| | Test | | | | | | | | | | | |
| | Voltage | % | 66 | 79 | 78 | 79 | 96 | 91 | 93 | 95 | 85 | 87 |
| | Retention | | | | | | | | | | | |

As shown in Table 1, the membrane electrode assemblies of Examples 1 to 6, which used crown ether dimers, exhibited significantly higher cell voltages after the durability test, and therefore showed higher voltage retention (i.e., smaller voltage drops) after the durability test and improved durability, compared with the membrane electrode assembly of Comparative Example 1, which did not use any crown ether, and the membrane electrode assemblies of Comparative Examples 2 to 4, which used crown ether monomers. Regarding the ring size of the crown ether dimer, the membrane electrode assemblies of Example 1 (ring size: 15) and Example 3 (ring size: 12) exhibited higher voltage retention 10 after the durability test, and thus further improved durability, compared with the membrane electrode assembly of Example 5 (ring size: 18). Regarding the linking group, the membrane electrode assemblies of Examples 1, 2, and 4 exhibited higher voltage retention after the durability test, and thus further improved durability, compared with the membrane electrode assembly of Example 6, which used a linking group having a longer main chain.

What is claimed is:

1. A membrane electrode assembly comprising:
a solid polymer electrolyte membrane;
an anode catalyst layer disposed on a first surface of the solid polymer electrolyte membrane; and
a cathode catalyst layer disposed on a second surface of the solid polymer electrolyte membrane, wherein:
the membrane electrode assembly contains a metal ion selected from cerium ions and manganese ions, and a compound that is able to coordinate to the metal ion; and
the compound that is able to coordinate to the metal ion is a compound having two or more macrocyclic ligands or a salt of the compound.

2. The membrane electrode assembly according to claim 1, wherein the compound that is able to coordinate to the metal ion is a compound in which two or more macrocyclic ligands are linked by a linking group, or a salt of the compound, and the macrocyclic ligands are crown ether structures.

3. The membrane electrode assembly according to claim 2, wherein the linking group is an alkylene group having 3 to 20 carbon atoms in a main chain, a —CH₂— in the main chain of the alkylene group may be substituted with at least one selected from —O— and —NR—, and R is independently a hydrogen atom or an alkyl group having one to six carbon atoms.

4. The membrane electrode assembly according to claim 1, wherein:
the compound that is able to coordinate to the metal ion is a compound in which two macrocyclic ligands are linked by a linking group;
the two macrocyclic ligands are identical and are crown ether structures having a ring size of 18 or less; and
the linking group is an alkylene group having 3 to 20 carbon atoms in a main chain, and two to four of —CH₂— units in the main chain of the alkylene group are substituted with at least one selected from —O— and —NR—, and R is independently a hydrogen atom or an alkyl group having one to six carbon atoms.

5. The membrane electrode assembly according to claim 4, wherein:
the two macrocyclic ligands are identical and are 12-crown-4 ether or 15-crown-5 ether; and
the linking group is an alkylene group having 3 to 12 carbon atoms in a main chain, and two of —CH₂— units in the main chain of the alkylene group are substituted with at least one selected from —O— and —NR—, and R is independently a hydrogen atom or an alkyl group having one to six carbon atoms.
